(19) United States
(12) Patent Application Publication
(10) Pub. No.: US 2003/0154165 A1
(43) Pub. Date: Aug. 14, 2003

(54) Method and arrangement for the transmission of an electronic sum of money from a credit reserve

(76) Inventors: Michael Horn, Munchen (DE); Hans-Hermann Wolf, Munchen (DE)

Correspondence Address: MORRISON & FOERSTER LLP, 1650 TYSONS BOULEVARD, SUITE 300, MCLEAN, VA, 22102, US

(21) Appl. No.: 10/344,853

(22) PCT Filed: Aug. 8, 2001
(86) PCT No.: PCT/EP01/09185

(30) Foreign Application Priority Data
Aug. 18, 2000 (EP) 00117857.3

(51) Int. Cl. G06F 17/60

(52) U.S. Cl. 705/39

(57) ABSTRACT

The invention relates to a method for the transmission of an electronic sum of money from a credit reserve of a money transmitter to a credit reserve of a money receiver, by means of a telecommunication and data network in real time. The transmission of the necessary data occurs by reference to a transaction number (TAN).

The invention relates to a method and an arrangement for transferring an electronic sum of money from a credit memory to an account or to another credit memory via a telecommunications and data network.

Besides for use as a means of communication and a source of information for what has now become hundreds of millions of people, the Internet is becoming increasingly important as a shopping source. Particularly trade in software, books and travel is already being carried out on the Internet in a significant proportion today, but also a broad spectrum of other goods and services is increasingly being ordered and paid for over the Internet. Paying for the relevant services on the Internet in the manner which was established originally and is still generally widespread today requires the relevant data records to be input separately in each case, at least by each party to the transaction, if not even for the individual transaction. This mode of payment thus allows the party to the transaction to see sensitive personal data and even to store them permanently.

The Internet has now also become considerably important for handling other payment transactions in the business and private sectors. Virtually all banks in industrial states offer electronic handling of account management and of payment transactions in the form of “electronic banking”.

Nevertheless, the majority of payment transactions in day-to-day life are, even today, still performed using cash or by providing transfer or direct debit orders or the like in writing, or by credit card or check card. In specific areas, for example that of mobile radio technology, electronic credits (“prepaid cards”) have also become significant, but considerable obstacles prevent this means of payment from being introduced on a widespread basis.

Altogether, it can be stated that, in the current state of development, there is an extremely confusing large number of options for paying for goods or services, and using said options in day-to-day life requires considerable alertness and requires a wide variety of media and modes of input to be dealt with. This is demanding and is also associated with diverse security risks (losing data media or credit media, forgetting account data and authentication codes etc.).

Besides the Internet, telecommunications—particularly mobile telecommunications—today represents an area of rapid technical and economic development and a significant source of economic growth and new social developments. For many of the people in industrial states, the mobile telephone (“mobile”) is increasingly becoming a universal communication and information instrument and is also increasingly being used to access goods and services. This development is also still hindered by insufficient opportunities for reliable and at the same time simple payment for information, goods and services ordered using a mobile.

Although solutions exist which allow the user of a mobile—with or without a prepaid card—to authorize payments, which are then processed in a conventional manner by debit procedures or credit card debiting. These methods presuppose, as do payment processing procedures which have now been introduced on the Internet, that the purchaser is creditworthy and has the authority to use a credit card or a current account with an overdraft facility. In addition, these procedures have inherent time lags which have an adverse effect on the transparency and reliability of the overall processing.

The invention is therefore based on the object of specifying a method and an arrangement for simplified processing of payment transactions using a data network.

This object is achieved in terms of its method aspect by a method having the features of claim 1 and in terms of its apparatus aspect by an arrangement having the features of claim 10.

The invention encompasses the fundamental concept of specifying a largely universal payment method on the basis of an electronic credit (prepaid account or card) which can be used for payment processing in the “B2C (Business-2-Consumer) sector” and also in the “C2C (Consumer-2-Consumer) sector”, that is to say allows shopping in real and virtual shops, payment in catering or cultural establishments or at automatic vending machines etc., and the “transfer” of sums of money in the private sector. It also encompasses the concept of using the opportunities of a linked telecommunications and data network in this regard, specifically the opportunity for processing in real time using a transaction number (TAN), in particular.

In the present case, an electronic credit is understood to mean a memory content in a credit memory which can be operated via a telecommunications or data network in order to perform payment transactions—in principle regardless of whether the memory actually has a prepaid credit or whether a credit sum is not transferred until a later time. In the description below and in the patent claims, the holder of the prepaid credit who wishes to transfer a sum of money and is in a (real or virtual) shop as a purchaser and in a catering establishment as a guest is referred to generally as the “money sender”. The receiver of the sum of money to be transferred, who will usually be the owner or operator of a shop or a catering or cultural establishment or the like in daily life, is referred to generally as the “money receiver” below. In addition, the money receiver and the money sender can also be applications.

The centerpiece in the proposed arrangement and in the proposed method is a transaction server which accesses a transaction database storing the data relevant for transferring prepaid credits. The transfer operation is initiated by the money sender or the money receiver calling the transaction server, specifically using a service call number or a special number for a service (e.g. 09XX); other connections are set up by the transaction server itself.

The sum of money to be transferred is input by the money sender or the money receiver on his respective terminal or on a cash register or other input device connected thereto. This can also be done in the second phase of a procedure in which initially the server's call number is input and is dialed and the money sender or money receiver is asked, by means of an announcement or by means of menu guidance, to input the sum of money. Following this request, he then makes the relevant input.

If a special number is used to set up a connection to the transaction server, an “originating trigger” in the caller's (money receiver's or money sender's) switch is used to identify the special number, to actuate the server—e.g. a service control center (SCP) in an intelligent network—and to activate the requested prepaid shopping application.

This application is preferably used within the scope of a subscription by the money receiver. In this context, the money receiver will normally specify a bank account to which the money transferred to his electronic credit memory within the scope of the prepaid shopping application is ultimately transferred. The transaction currency can also be specified. The money sender does not need to take out a subscription for the money transfer procedure. For security reasons, however, it is preferable for the money transfer to be authorized using predetermined authentication means; in this regard, see further below.

The preferred subscription to the service by the money receiver is likewise not absolutely necessary. With no formal subscription, however, it is not possible to specify any bank details, which means that the sum of money transferred to the electronic credit memory (“prepaid account”) cannot be transferred further. Since, additionally, a currency cannot be specified, the application is normally limited to the currency which is valid in the money sender's or money receiver's country. In this form, the method is particularly suitable for the transfer of money between private persons (“C2C”).

When the connection or connections to the transaction server has/have been set up, the necessary inputs and outputs can be made using a voice link with voice input or DTMF input and voice output, on the one hand, and by exchanging text messages (particularly SMS or e-mail), or else using a combination of these, on the other.

The aforementioned subscription process involves a data record relating to the money receiver being stored in the transaction database (“shopping database”). The money receiver's account needs to be suitable for the management of electronic credits; it can likewise be a prepaid account, in particular. The money receiver can use a plurality of telephone numbers and also a plurality of destination accounts for the transfer of money, in which case all the telephone numbers to be used and account identifiers for all the accounts naturally need to be stored in the shopping database. (The term “account identifier” is understood below to mean an account number or an account code and the possibly required server address of an external server on which the account is managed, as a whole.) Besides the aforementioned data, the money receiver data record stored in the transaction database expediently also comprises a name or company name.

Besides the information relating to the money receiver, the shopping database preferably also contains the information about the money sender which is required for performing the money transfer. This money sender data record expediently contains the account number of his prepaid account and, if required, the server address of an external server on which the prepaid credit is managed (also occasionally referred to in the present case as “account identifier” below), advantageously also the server and operator names and, finally, an authentication data record for authenticating larger money transfers at least optionally on a case-by-case basis. The “address” or “key” used for this data record is expediently the money sender's call number.

The money sender data record can also be stored in a separate prepaid database.

In one preferred implementation of the method, a transaction number specifying the individual transaction is used as a central reference point for the individual method steps. This transaction number is generated by the transaction server as a random number and is valid for a preset time within which the money transfer operation should have been completed.

Details of the use of the transaction number are described further below.

A fundamental security component is the aforementioned authentication data record within the money sender data record. The authentication data record comprises, in particular, an authentication code (PIN or the like) and/or biometric data for the money sender (e.g. papillary line or retina pattern), which code and/or data are used for authorizing money transfers on a case-by-case basis. This code and these data are input on the money sender's terminal or on an input unit associated therewith, are transmitted to the transaction server and are compared there with the corresponding stored data. The result of the comparison is that the transaction is enabled or blocked.

In one preferred implementation of the method, the aforementioned authorization steps are not performed for very small sums, but only for sums of money which exceed a predetermined threshold value. This threshold value can advantageously be set and changed by the service operator or by the money sender himself.

The proposed solution comprises the function blocks (1) starting the money transfer procedure, (2) debiting from the money sender and (3) crediting the money receiver. These function blocks can be executed on one and the same server or on different servers covered jointly by the term “transaction server”. The server or servers can exist centrally with one service operator or in a plurality of hardware implementations with this service operator or with a plurality of service operators. The prepaid shopping application has—as already mentioned above—access to a “shopping database” which (depending on the specific network and application concept) can likewise be provided centrally at one point, distributed over a plurality of points or else can be provided in a plurality of copies at a variety of points.

The method and arrangement take the simplest form when the money sender's prepaid credit, the money receiver's destination account and the prepaid shopping application itself are managed or operated by one and the same service operator. If this is not the case, clearing (known as such) needs to take place for the money transfer. For this operation, the documentation created in the debit and credit operation, particularly in the form of “log records”, can be used.

As a real time method, the proposed method affords improved transparency and reliability as compared with known payment processing methods and can also be used, in particular, by people who have not been granted a credit facility. The user need merely have a prepaid credit ensuring sufficient coverage of the envisaged money transfer.

In addition, the proposed system affords the considerable advantage that the electronic money held in a prepaid account can be used not only for paying for a service having a narrow specification (specifically telephone calls), but also in diverse ways for paying for goods, services, information etc. in real or in virtual sales establishments of all kinds. Prepayment of the credit gives the user strict cost control, and in principle it is not possible to get into debt unintentionally. This means that this method can also be used with particular advantage for minors (or else for older people who are no longer in full possession of their mental faculties), for whom there has been no comparable application to date. For paying for goods or services from different suppliers, it is no longer necessary to have a plurality of prepaid cards or terminals, but rather only a single prepaid call number need be stored.

Other advantages and expediencies of the invention can be found in the subclaims and in the description below of a preferred exemplary embodiment with reference to the figures, in which:

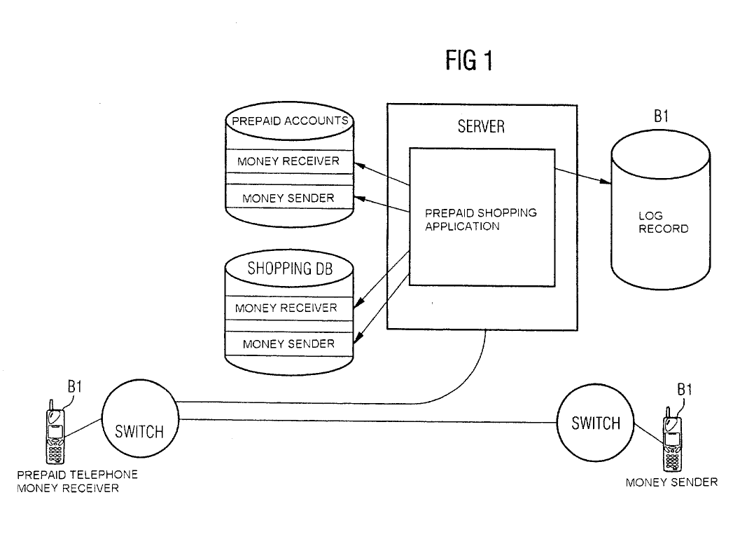

FIG. 1 shows a greatly simplified function block diagram of a first embodiment of the inventive arrangement,

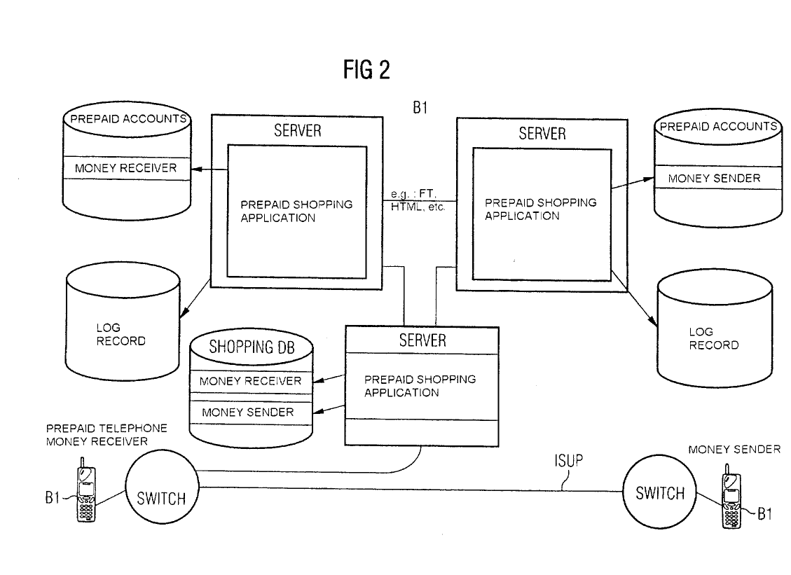

FIG. 2 shows a greatly simplified function block diagram of a second embodiment,

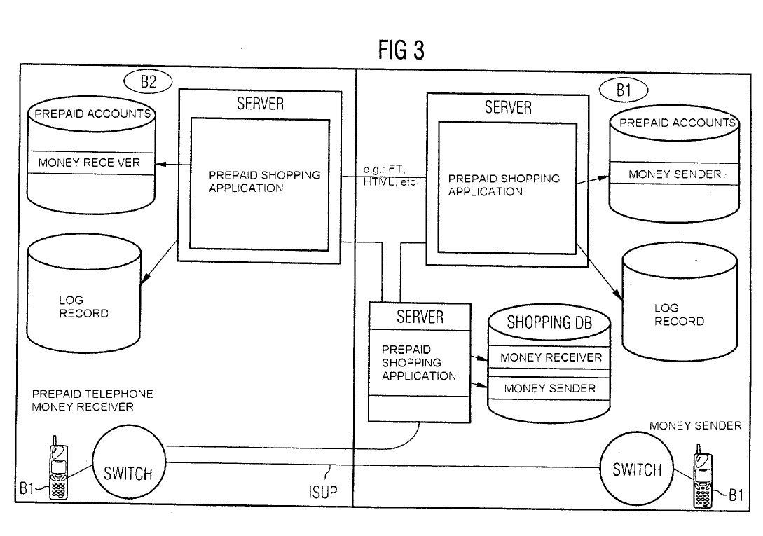

FIG. 3 shows a greatly simplified function block diagram of a third embodiment, and

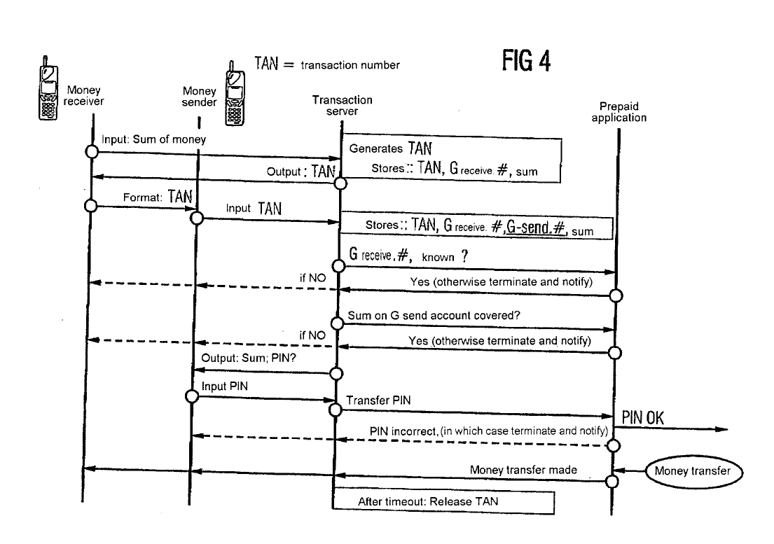

FIG. 4 shows a schematic illustration of fundamental steps in the proposed application for the arrangement shown in FIG. 1.

The labeling in the figures makes them fundamentally self-explanatory, so that no detailed description of the figures is given below.

Attention is drawn to the fact that, in FIG. 1, the assumption is made that the prepaid shopping application runs on the same server as that on which prepaid accounts belonging to the money receiver and money sender are managed. By contrast, FIG. 2 shows the situation in which prepaid accounts belonging to the money sender and money receiver are managed on a different server (associated with the same operator Bi) than that on which the prepaid shopping application is running. FIG. 3 shows the situation in which the prepaid shopping application and prepaid accounts which it operates are managed on different servers associated with different operators Bi, B2. FIGS. 1 to 3 show the situation in which the transaction server SERVER is called by the money receiver's terminal; if these figures are modified by replacing the connection between the money receiver's switch and the server with a connection between the money sender's switch and the server, they show the situation in which the money sender calls the transaction server.

The money transfer process is initiated by virtue of the money receiver or the money sender calling the transaction server SERVER. In this context, following a server call number—separated therefrom by a star (*)—the sum of money to be transferred is input on the money sender's or money receiver's terminal in the relevant currency as an unstructured digit sequence. In another variant, a direct call number for the transaction server is input in order to start the prepaid shopping application thereon. To this end, the terminal's keyboard is used, in particular; in principle, it is also possible to use voice input within the context of appropriately designed menu control, however. Provided that the price has not been input in conjunction with the dialing procedure, the prepaid shopping application starts an announcement asking the calling party to input the price The caller then inputs the price.

Following input, the transaction server generates a random number which is used as a transaction number TAN for the money transfer. The numerical range from which this random number is obtained should be large enough for a TAN to be available for every transaction within the time interval estimated for the transaction in a domain (e.g. a country) associated with an operator. (Should the case arise, by way of exception, that no more random numbers are available, further money transfers need to be postponed until a timeout results in a TAN becoming free again.)

With the TAN as the key or address, the sum of money input by the caller (money sender or money receiver) and his automatically or manually transmitted call number are stored in the transaction database.

The TAN is then transmitted to the caller. After that, the connection between the caller and the transaction server is cleared down.

The other party to the money transfer is then notified of the TAN in another way, e.g by means of visual display on the display on a cash register held with the money receiver or money sender. The money receiver or the money sender then calls the transaction server. This can again be done by dialing a direct server call number or the aforementioned special number. In the first case, the prepaid shopping application starts an announcement asking for the TAN to be input. In the latter case, the TAN can be input following the special number—possibly separated by a star. In this case too, an originating trigger in the money sender's or money receiver's switch is again used to identify the special number, to actuate the transaction server and to activate the prepaid shopping application thereon.

When the TAN has been input, the transaction database is addressed using the TAN, and the caller's (money sender's or money receiver's) call number—again transmitted automatically or manually—is entered into the data record.

The prepaid shopping application on the transaction server then transfers the data required for transferring the money (particularly the money receiver's and money sender's call numbers and the sum of money) to a prepaid application on a corresponding server. This can be the transaction server itself (FIG. 1) or at least one server belonging to the same operator (FIG. 2) or at least one server belonging to another operator (FIG. 3) . The applications can also run on different servers, having been distributed in modules.

When the data have been transmitted, which means that the transfer procedure has been started, a checking process is first carried out to determine whether the data medium is valid and whether the sum in the money sender's prepaid account is sufficient for the envisaged transfer process. If both are the case, the money sender is asked to input his PIN in order to authorize the debit operation on the sum of money to be transferred.

The checking process involves the prepaid shopping application accessing the shopping database and reading the money receiver data record and the money sender data record with the information contained therein regarding which server or which servers (and which operator or which operators) hold the accounts of the money receiver and the money sender. The money sender's server is identified and, if it is a server other than that on which the prepaid shopping application is running, a real-time connection to a prepaid shopping application running on this foreign server is set up.

The prepaid shopping application on the money sender's server is sent a request to check whether the electronic credit in the money sender's prepaid account is sufficient for the envisaged money transfer. If this is not the case, the transfer is terminated with a corresponding advice signal to the money receiver's and/or money sender's terminal. If the sum of money to be transferred is covered, it is reserved in the money sender's prepaid account.

The aforementioned authorization is then given by virtue of the money sender inputting the PIN. The PIN which is input is compared with the PIN stored in the money sender data record. If it is valid, the debiting process is initiated. If it is not valid, the transaction is terminated at this point and a corresponding advice signal is again transmitted.

The sum of money to be transferred is then debited from the money sender's prepaid account. This process is time-critical and is performed in real time. If the money sender's prepaid account is on the same server as the prepaid shopping application, the credit can immediately (in real time) be reduced by the sum of money which is to be transferred. If the account is on a foreign server, the debit request needs to be made to the prepaid shopping application on that server, and the debit operation is performed under that application's regime. In all cases, a log record is created for the debiting process, and the cash register system or a call or SMS or the like is used to inform the money receiver and/or money sender that the debit operation has been performed.

The sum of money to be transferred is then credited to the money receiver's account, which can be a prepaid account, a real-time account or a normal bank current account. This process is not time-critical but needs to take place with the utmost reliability. In this case too, a distinction needs to be drawn between the aforementioned debiting variants—according to whether or not the account is managed on a foreign server. A log record is also created for the crediting process.

The implementation of the invention is not limited to the aforementioned examples, variants and aspects; rather, the claims likewise permit a large number of modifications for it which are within the scope of technical action. In particular, the method steps described above are also possible in a different order.

To reduce the number of input steps, the processes of the TAN being input by the money sender and the money transfer process being authorized by means of a PIN can also be combined into one step. Of the various options for this, reference is made to two: in the case of the first, the money sender relies on the money receiver having input the sum of money to be transferred correctly, and inputs his PIN as well immediately after the TAN has been input. The sum of money is initially debited from his prepaid account without any further check. For the purposes of confirmation, the money sender is then told the sum of money which has been transferred. If it is incorrect, the money sender can cancel the money transfer by inputting the TAN and a correction code (for example the price “0”) again. This needs to be done within the TAN's validity period and results in the sum of money being transferred back. In the second variant, the money sender transmits the TAN, the sum of money, and the PIN—respectively subdivided by a separator. If the specific system also provides for the money receiver to input a sum of money, the transaction is performed only if there is a match; if there is no match, on the other hand, the transaction is terminated and corresponding notification is sent to the money receiver and to the money sender.

Specific advantages of the solution claimed are that the money sender can remain anonymous, and no long call numbers need to be exchanged between money sender, money receiver and transaction server, but rather only the short TAN. This shortens the length of the transaction procedure and reduces the error rate for input. For each transaction, the money receiver or the money sender need call the transaction server and input the sum of money just once, and he saves time for other activities.

1. A method for transferring an electronic sum of money from a credit memory associated with a money sender, which contains a prepaid credit, in particular, to an account or to a credit memory associated with a money receiver via a telecommunications and data network in real time, having the following steps:
a money receiver data record, comprising at least one call number for a terminal associated with the money receiver in the telecommunications network and an account identifier for the money receiver's account or credit memory, is stored in a transaction database and/or in a credit management database, with at least the call number being stored in the transaction database, particularly within the context of the money receiver's subscription to a money transfer service with a service provider,
a money sender data record, comprising at least one call number for a terminal, an account identifier for the credit memory and, optionally, an authentication data record for the money sender, is stored in the transaction database and/or in a credit management database,
a connection is split up between the money receiver's or money sender's terminal and a transaction server associated with the service operator using a server call number or special number, with the transaction server generating a unique transaction number for the transfer operation and assigning it to the money receiver data record and/or to the money sender data record as an address and transmitting the transaction number to the respective caller, and the other party to the money transfer, i.e. the money sender or money receiver, returning said transaction number in a response to the transaction server together with further data, particularly authentication data,
the sum of money to be transferred is input on the money receiver's or money sender's terminal and is transmitted to the transaction server,
the transaction server reads the money receiver data record and, optionally, the money sender data record from the transaction database and evaluates it/them, which includes setting up (an) optionally required data link(s) to one or more external application(s),
the coverage of the sum of money is checked in the money sender credit memory, and the sum of money is reserved if it is covered, or the process is terminated with signaling if there is insufficient coverage,
the sum of money is debited from the money sender credit memory, and this is documented,
the sum of money is credited to the money receiver account or to the money receiver credit memory, and this is documented,
information about the debit and/or credit operation is transmitted to the money receiver's and/or money sender's terminal.

2. The method as claimed in claim 1, characterized in that the transaction number is assigned a predetermined validity period.

3. The method as claimed in claim 1 or 2, characterized in that the sum of money to be transferred is input in conjunction with the server call number.

4. The method as claimed in claim 1 or 2, characterized in that
the transaction server generates and transmits a request for input of the sum of money which is to be transferred to the money sender and/or money receiver, and this request is output on the money sender's and/or money receiver's terminal, and
in response to this request the sum of money is input on the respective terminal.

5. The method as claimed in one of the preceding claims, characterized in that the authentication data record in the money sender data record comprises an authentication code or biometric data for the money sender, and, before the debit operation step, steps for authorizing said debit operation are performed, namely the following steps:
the authentication code or the biometric data is/are input by the money sender on his terminal,
the input is transmitted to the transaction server, and
the transmitted data are compared with the data held in the money sender data record, and a debit enable signal is output if there is a match and a debit block signal is output if there is no match.

6. The method as claimed in claim 5, characterized in that the authorization steps are performed for a sum of money which exceeds a predetermined threshold value and which can be set by the service provider or the money sender in particular..

7. The method as claimed in one of the preceding claims, characterized by its being performed by setting up a data link to at least one external server on which the money sender credit memory and/or the money receiver account or the money receiver credit memory are managed, the account identifier of the money receiver data record and/or the account identifier of the money sender data record comprising a server address or server call number, and the transaction server being connected to this or these following the step of reading the money receiver data record and the money sender data record in order to perform the subsequent steps.

8. Method as claimed in one of the preceding claims, characterized in that the money receiver takes out a subscription with the service operator using
a plurality of accounts and/or call numbers, the number of accounts being less than the number of call numbers, in particular, and all the corresponding account identifiers and call numbers being stored in the money receiver data record.

9. The method as claimed in one of the preceding claims, characterized in that the transaction number is indicated visually or audibly on the caller's terminal or on a data processing appliance or cash register connected thereto.

10. Arrangement for transferring an electronic sum of money from a credit memory associated with the money sender, which contains a prepaid credit, in particular, to an account or to a credit memory associated with a money receiver via a telecommunications and data network in real time, particularly in order to carry out the method as claimed in one of the preceding claims, which has:
at least one account management server having a money sender credit memory and a money receiver account or credit memory,
a money receiver terminal connected to the telecommunications and data network,
a money sender terminal connected to the telecommunications and data network,
a transaction database associated with a service provider, which stores a money receiver data record, comprising the transaction call number of the money receiver's terminal and/or an account identifier for the account or credit memory and a money sender data record comprising the call number of a terminal associated with the money sender and/or an account identifier for the credit memory, and optionally an authentication data record, and
a transaction server which is connected to the transaction database and can be connected to the money sender's and/or money receiver's terminals by means of a server call number or special number and can be connected to the account management server or to the account management servers by means of a data link or which is an integral part of said account management server or account management servers,
for reading and for evaluating the money'receiver data record and the money sender data record from the transaction database or from the account management server or account management servers, and for setting up (an) optionally required data link(s) to one or more external application(s) and for controlling a coverage check in the money sender credit memory and a debit operation on the latter and a credit operation on the money receiver account or money receiver credit memory, where the transaction server has random-number generator means for generating a transaction number for uniquely identifying a money transfer operation and combination logic means for assigning the transaction number to the money receiver data record and/or money sender data record in the transaction database.

11. The arrangement as claimed in claim 10, characterized in that the transaction server has timer means for stipulating a validity period for the transaction number, said timer being started when said transaction number is generated.

12. The arrangement as claimed in claim 10 or 11, characterized in that the transaction database and the money sender credit memory and/or the money receiver credit memory are implemented on the transaction server.

13. The arrangement as claimed in one of claims 10 to 12, characterized in that the transaction server has means for documenting a debit operation and a credit operation, particularly in the form of a log record.

14. The arrangement as claimed in one of claims 10 to 13, characterized in that the transaction server has associated telecommunication means for signaling termination of a transaction or a debit operation and/or a credit operation to the money sender's and/or money receiver's terminal.

15. The arrangement as claimed in one of claims 10 to 14, characterized in that the telecommunications and data network comprises a mobile radio network, with the money sender's terminal and/or the money receiver's terminal being in the form of a mobile radio terminal or a data processing appliance equipped with a mobile radio part, and a transaction server having an associated mobile radio terminal.

16. The arrangement as claimed in one of claims 10 to 15, characterized in that the money sender's terminal and/or the money receiver's terminal is equipped with a display device for displaying the transaction number or is connected to an appliance having a display unit via a wired or wireless interface, particularly an infrared interface or a Bluetooth interface.
